(19) United States
(12) Patent Application Publication
(10) Pub. No.: US 2026/0296068 A1
(43) Pub. Date: Oct. 1, 2026

(54) METHOD AND A MULTI-LANE PRINTER FOR PRINTING ON PRINT MEDIA

(71) Applicant: CANON KABUSHIKI KAISHA, Tokyo (JP)

(72) Inventors: Eduardus J.W. VAN VLIEMBERGEN, Tegelen (NL); Dirk G. PETERS, Waalre (NL); Marcus H.G.W. Hees, Echt (NL); Jelle van Enckevort, Horst (NL)

(21) Appl. No.: 19/578,693

(22) Filed: Mar. 25, 2026

(30) Foreign Application Priority Data
Mar. 27, 2025 (EP) 25166538.6

(51) Int. Cl. B41J 11/00; B41J 3/62; G06F 3/12

(52) U.S. Cl. CPC B41J 11/0095; B41J 3/62; B41J 11/0085; G06F 3/121; G06F 3/1234

(57) ABSTRACT

A method for a printer comprises determining different positions in parallel lanes for the individual print media, the positions spread in a direction perpendicular to a scanning direction of a print station, transporting in parallel but not necessarily simultaneously print media perpendicular to a scanning direction of the print station in parallel lanes towards a medium support plane, and based on the determined different positions, independently activating a signaling object in each lane when a leading edge of a fed print medium reaches each of the different positions in the lane. Each determined position in a lane has a different distance to a start position for a start of an automatic transport of the print medium to the medium support plane for ejecting marking material on the print medium by the print station, and each determined position corresponds to a different signal given by the signaling object when activated.

### CROSS-REFERENCE TO RELATED APPLICATIONS

This application claims priority to European Patent Application No. 25166538.6 filed on March 27, 2025, which is incorporated by reference herein in its entirety.

### BACKGROUND OF THE DISCLOSURE

### Field of the Disclosure

The present disclosure relates to a method for a printer comprising a transport device comprising an endless transport belt supported on a pair of support rollers, which between them define a medium support plane, over which medium support plane a print station is provided. The method comprises the steps of determining a plurality of different positions in the plurality of parallel lanes for the individual print media, the plurality of positions spread in a direction perpendicular to a scanning direction of the print station and transporting in parallel but not necessarily simultaneously a plurality of individual print media perpendicular to a scanning direction of the print station in a plurality of parallel lanes towards the medium support plane.

The present disclosure also relates to a printer, specifically a large format hybrid printer, which comprises a print controller which is configured to execute the steps of the method according to the present disclosure.

### Description of Background Art

The media support plane may also be called “table” hereinafter.

A rigid print medium may also be called “rigid,” “board” or “rigid board.”

The print medium may also be called “print media” or “print media piece.”

The belt may also be called as the media support plane.

A left side and a right side of the alignment is determined by a viewing position of the operator towards a front of the printer, i.e. towards the front of the printer when feeding print media into the printer.

Large format hybrid printers are configured to print both rigid substrates as well as flexible print media. Such a printer may comprise a transport device comprising an endless transport belt supported on at least one pair of support rollers, which between them define a medium support plane. Over the medium support plane, a print station is provided. The print station generally comprises a printhead carriage translatable over the belt to print an image on a print medium on the belt in consecutive swaths. The print medium is moved in steps in between passes of the printhead carriage.

A large format hybrid printer is intended to be a productive engine capable of printing both on roll-2-roll media and on rigids. To be productive on rigids, the printer is equipped with a multilane concept. With this, multiple rigids can be printed in parallel next to each other. The multilane concept increases productivity since there will be less “turn time” for the print station compared to “jetting time.”

In order to enhance an overall productivity and to reduce operator hassle, the printer supports the feature of independent board feeding, i.e. the print medium does not need to be aligned in the transport direction.

The lanes of the printer are not mapped directly to the queues. For example, in a dual queue view the odd lanes may be mapped to a first queue and the even lanes may be mapped to a second queue, while in a single queue view all lanes are mapped to a single queue. However, not all available lanes can always be used. For example, if a job is left aligned then only the odd lanes may be used, even in the single queue view. For example, if a job has to be printed on different media or with a different print mode it cannot be printed at the same time as the previous job, which in fact means that this job also blocks all other lanes. For example, lanes may also be disabled in order to get a better productivity. For example, there has to be some distance between two rigids.

Therefore it becomes unclear for a user when he is allowed to feed a rigid.

In addition, the user also has to make sure that the front edge of the rigid is within a rather small area in order to be able to detect the front edge by means of an area camera as well as being at the right position for the vacuum zones and to be printed.

### SUMMARY OF THE DISCLOSURE

The present disclosure is directed to assisting the user in placing the rigids in the correct lanes at the right position.

In accordance with the present disclosure, a method for printing is provided.

Based on the determined plurality of different positions, a signaling object is independently activated in each lane when a leading edge of a fed individual print medium reaches each of the different positions in the lane. Each determined position in a lane has a different distance to a start position for a start of an automatic transport of the print medium to the medium support plane for ejecting marking material on the print medium by the print station, and each determined position in the lane corresponds to a different signal given by the signaling object in the lane when activated.

According to an embodiment, the method comprises the step of the signaling object communicating to an operator of the printer that the fed print medium in a lane is not near the start position, almost reaching the start position, at the start position, just beyond the start position but correctable by retraction, or far beyond the start position and not retractable. When the fed print medium is at a standstill at the start position, a camera above the print medium will detect the leading edge of the print medium. The endless transport belt is moving but will not get grip on the print medium, since a vacuum system below the belt is off. As soon as the leading edge is detected by the camera, the print controller will activate the vacuum system such that the belt gets a grip on the print medium. The print medium will then be transported by the belt to the print station. The vacuum system is configured to suck the print medium per lane which enables an independent feeding of print media in the different lanes.

According to an embodiment, the method comprises the step of cancelling the print action before the print medium reaches the print station when the signaling object is communicating that the fed print medium is far beyond the start position and not retractable.

According to an embodiment, the method comprises the steps of the signaling object blinking when the fed print medium is almost reaching the start position or the fed print medium is just beyond the start position and the signaling object is on in the other positions.

According to an embodiment, the method comprises the steps of the signaling object blinking green when the fed print medium has almost reached the start position and the signaling object blinking red when the fed print medium is just beyond the start position but retractable.

According to an embodiment, the method comprises the steps of the signaling object is on and solid signaling white or blue when the fed print medium is at the start position and the signaling object solid signaling red when the fed print medium is far beyond the start position and not retractable.

According to an embodiment, the method comprises the step of turning off the signaling object when the lane is not available.

According to an embodiment, the printer is provided with a camera system above the print medium surface and the method comprises the step of the camera system detecting a leading edge of the print medium.

According to an embodiment, the method comprises the step of, when the lane is not available, the signaling object starting blinking red when a print medium is fed into the lane and detected by the camera system.

According to an embodiment, the method comprises the steps of, when the signaling object is solid signaling white or blue, turning on a vacuum system to hold the print medium at its place, turning off the signaling object, the camera system detecting the leading edge of the print medium, and activating the transport belt for a transport of the print medium to the print station.

According to an embodiment, the signaling object is a LED light indication.

The present disclosure also relates to a printer comprising a transport device comprising an endless transport belt supported on a pair of support rollers which between them define a medium support plane, over which medium support plane a print station is provided, wherein the printer comprises a plurality of lanes for feeding the print media to be printed upon, wherein above each lane a signaling element is provided, and a print controller which is configured to execute the steps of a method according to the present disclosure.

According to an embodiment, the printer comprises at least one camera system to detect a feeding of a print medium in the print medium plane.

According to an embodiment, the printer is a hybrid printer for printing on rigid print media as well as on flexible print media.

The present disclosure also relates to a non-transitory computer-readable storage medium storing program code, which when loaded into a print controller of a digital printer according to the present disclosure, causes the print controller to execute the steps of the method according to the present disclosure.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure, and wherein:

FIG. 1 is a schematic perspective view of a printing system configured to print on rigids according to the present disclosure;

FIG. 2 is a schematic perspective view of a printing system in FIG. 1 configured to print on a roll of media according to the present disclosure;

FIG. 3 is a schematic diagram of a control unit of a printer according to FIG. 1 or 2;

FIG. 4 is a schematic view of the media support plane of the printer according to FIG. 1;

FIG. 5 is a schematic diagram of the different positions of the fed print media on the media support plane according to the present disclosure;

FIG. 6 is a flow diagram illustrating the steps of a method according to the present disclosure; and

FIG. 7 is a diagram of a software product according to the present disclosure.

### DETAILED DESCRIPTION OF THE EMBODIMENTS

The present disclosure will now be described with reference to the accompanying drawings, wherein the same reference numerals have been used to identify the same or similar elements throughout the several views.

### Printing system

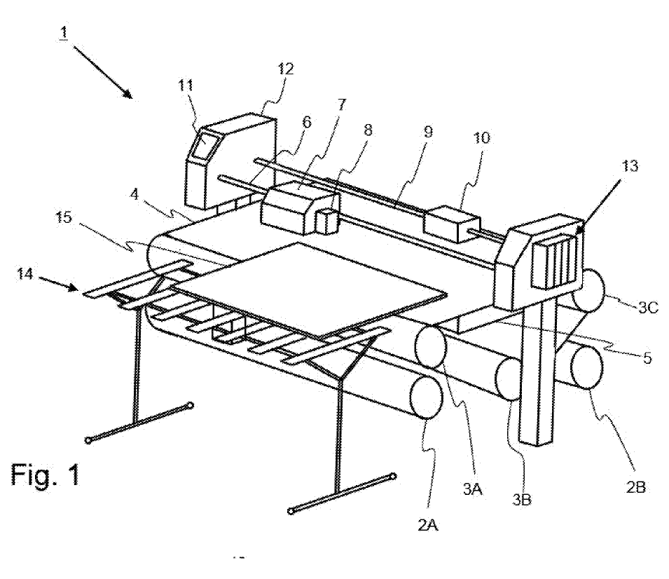

FIG. 1 shows a wide format inkjet printer 1. The wide-format printer 1 comprises an inkjet printing assembly 7 for printing on a print medium 15. The print medium 15 in FIG. 1 is a relatively rigid substrate, such as a panel. The print medium 15 is supplied from a media input unit 14, which may be configured for storing a plurality of such print media 15 and supplying them to the printer 1. The printer 1 comprises transport means for receiving and transporting the print medium 15 along the inkjet printing assembly 7. In FIG. 1, the transport means comprises an endless transport belt 4 supported on a plurality of support rollers 3A, 3B, 3C. At least one of the support rollers 3A, 3B, 3C is provided with driving means for moving the belt 4. Additionally, one or more one of the support rollers 3A, 3B, 3C may be configured to be moved and/or tilted to adjust and control the lateral position of the belt 4. The printer 1 is provided with at least one sensor or detector, such as a CCD camera or area camera, to determine the relative position of the belt 4 and/or the print medium 15. Data from said at least one sensor or detector may be applied to control the position of the belt 4 and/or the print medium 15. The at least one sensor or detector is positioned in or at a housing (not shown) of the printer 1 and is configured to detect the print medium 15 before transporting the print medium 15 or before the print medium reaches the print station 7. By using cameras, the print medium 15 can be detected over a full width of the medium support plane, and before the print station 7 will start printing on the print medium 15. The at least one sensor or detector can also sense or see alignment bars (not shown) positioned on the media input unit 14 extending towards the medium support plane. According to an alternative embodiment, the at least one sensor or detector is integrated in the medium support plane.

The belt 4 is further provided with through-holes and a suction box 5 in connection with a suction source (not shown), such that an underpressure may be applied to the print medium 15 via the through-holes in the belt 4. The underpressure adheres the print medium 15 flatly to the belt 4 and prevents displacement of the print medium 15 with respect to the belt 4. Due to this holding, the belt 4 is able to transport the print medium 15. It will be appreciated that other suitable transport means, such as rollers, steppers, etc., may alternatively be applied. The print medium 15 may be transported stepwise and/or in continuous movement.

The inkjet printing assembly 7 is configured to translate along a first guide beam 6 in a scanning direction. The scanning direction is perpendicular to the direction in which the print medium is transported by the belt 4. The inkjet printing assembly 7 holds a plurality of print heads (not shown), which are configured to jet a plurality of different marking materials (different colors of ink, primers, coatings, etc.) on the print medium 15. Each marking material for use in the printing assembly 7 is stored in one of a plurality of containers arranged in fluid connection with the respective print heads for supplying marking material to said print heads to print an image on the print medium 15.

The ejection of the marking material from the print heads is performed in accordance with data provided in the respective print job. The timing by which the droplets of marking material are released from the print heads determines their position on the print medium 15. The timing may be adjusted based on the position of the inkjet printing assembly 7 along the first guide beam 6. The above-mentioned sensor 8 may therein be applied to determine the relative position and/or velocity of the inkjet printing assembly 7 with respect to the print medium 15. Based upon data from the sensor 8, the release timing of the marking material may be adjusted.

Upon ejection of the marking material, some marking material may be spilled and stay on a nozzle surface of the print heads. The marking material present on the nozzle surface may negatively influence the ejection of droplets and the placement of these droplets on the print medium 15. Therefore, it may be advantageous to remove excess marking material from the nozzle surface. The excess marking material may be removed, for example, by wiping with a wiper and/or by application of a suitable anti-wetting property of the surface, e.g. provided by a coating.

The marking materials may require treatment to properly fixate them on the print medium. Thereto, a fixation unit 10 is provided downstream of the inkjet printing assembly 7. The fixation unit 10 may emit heat and/or radiation to facilitate the marking material fixation process. In the example of FIG. 1, the fixation unit 10 is a radiation emitter, which emits light of certain frequencies that interacts with the marking materials, for example UV light in case of UV-curable inks. The fixation unit 10 in FIG. 1 is translatable along a second guide beam 9. Other fixation units 10, such as page-wide curing or drying stations may also be applied. Further, the inkjet printing assembly 7 may be provided with a further fixation unit on the same carriage which holds the print heads. This further fixation unit can be used to (partially) cure and/or harden the marking materials, independent of or interaction with the fixation unit 10.

After printing, and optionally fixation, the print medium 15 is transported to a receiving unit (not shown). The receiving unit may comprise a take-up roller for winding up the print medium 15, a receiving tray for supporting sheets of print medium 15, or a rigid media handler, similar to the media input unit 14. Optionally, the receiving unit may comprise processing means for processing the medium 15 after printing, e.g. a post-treatment device such as a coater, a folder, a cutter, or a puncher.

The wide-format printer 1 furthermore comprises a user interface 11 for receiving print jobs and optionally for manipulating print jobs. The local user interface unit 11 is integrated to the print engine and may comprise a display unit and a control panel. Alternatively, the control panel may be integrated in the display unit, for example in the form of a touch-screen control panel. The local user interface unit 11 is connected to a control unit 12 connected to the printer 1. The control unit 12, for example a computer, comprises a processor adapted to issue commands to the printer 1, for example for controlling the print process. The printer 1 may optionally be connected to a network. The connection to the network can be via cable or wireless. The printer 1 may receive printing jobs via the network. Further, optionally, the control unit 12 of the printer 1 may be provided with an input port, such as a USB port, so printing jobs may be sent to the printer 1 via this input port.

### Hybrid printing system

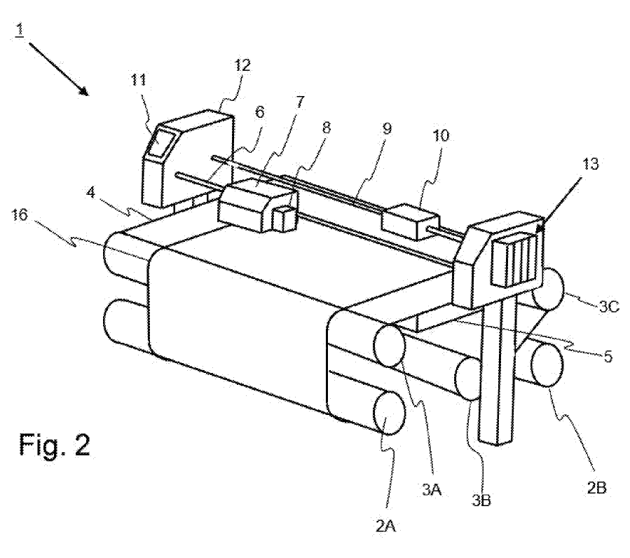

The printer 1 in FIG. 1 is a so-called hybrid printer, capable of handling both flexible media and rigid substrates. In FIG. 1, the printer 1 operates in a first print mode, wherein the printer 1 is configured for transporting rigid substrates, such as the print medium 15. Such rigid print media 15 may be panels for doors, walls, etc., corrugated media, plates formed of plastic or metal, etc. To handle these rigid print media 15, the printer 1 in FIG. 1 is configured with a substantially linear transport path: from the media input device 14, the print medium 15 moves forward along the inkjet printing assembly 7 at a substantially constant height. The media input unit 14 and the receiving unit are positioned at the level of the medium support surface of the belt 4. In FIG. 2, a flexible web medium 16 is supplied to the printer 1, which web medium 16 may be composed of e.g. paper, label stock, coated paper, plastic or textile. The web medium 16 is supplied from the input roller 2A and extends across the belt 4 to the take-up roller 2B, where the web medium 16 is re-wound. The printer 1 is configured to swiftly and efficiently switch between print modes.

### Control

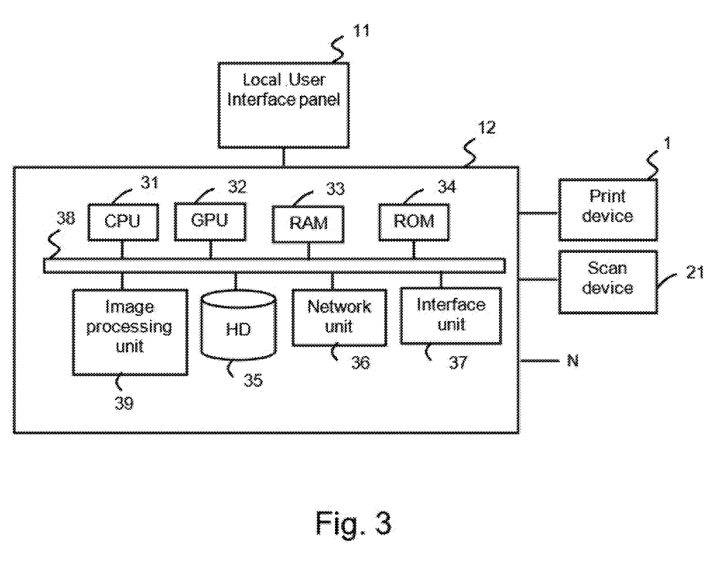

An embodiment of the control unit 12 is in more detail presented in FIG. 3. As shown in FIG. 3, the control unit 12 comprises a Central Processing Unit (CPU) 31, a Graphical Processor Unit (GPU) 32, a Random Access Memory (RAM) 33, a Read Only Memory (ROM) 34, a network unit 36, an interface unit 37, a hard disk (HD) 35 and an image processing unit 39 such as a Raster Image Processor (RIP). The aforementioned units 31 - 37 are interconnected through a bus system 38. However, the control unit 12 may also be a distributed control unit.

The CPU 31 controls the printing system 1 in accordance with control programs stored in the ROM 34 or on the HD 35 and the local user interface panel 11. The CPU 31 also controls the image processing unit 39 and the GPU 32. The ROM 34 stores programs and data such as boot program, set-up program, various set-up data or the like, which are to be read out and executed by the CPU 31. The hard disk 35 is an example of a non-volatile storage unit for storing and saving programs and data which make the CPU 31 execute a print process to be described later. The hard disk 35 also comprises an area for saving the data of externally submitted print jobs. The programs and data on the HD 35 are read out onto the RAM 33 by the CPU 31 as needed. The RAM 33 has an area for temporarily storing the programs and data read out from the ROM 34 and HD 35 by the CPU 31, and a work area which is used by the CPU 31 to execute various processes. The interface unit 37 connects the control unit 12 to the client device 21 and to the printing system 1. The network unit 36 connects the control unit 12 to the network N and is designed to provide communication with workstations and with other devices reachable via the network N. The image processing unit 39 may be implemented as a software component running on an operation system of the control unit 12 or as a firmware program, for example embodied in a field-programmable gate array (FPGA) or an application-specific integrated circuit (ASIC). The image processing unit 39 has functions for reading, interpreting and rasterizing the print job data. Said print job data contains image data to be printed (i.e. fonts and graphics that describe the content of the document to be printed, described in a Page Description Language or the like), image processing attributes and print settings.

### Multi-lanes concept

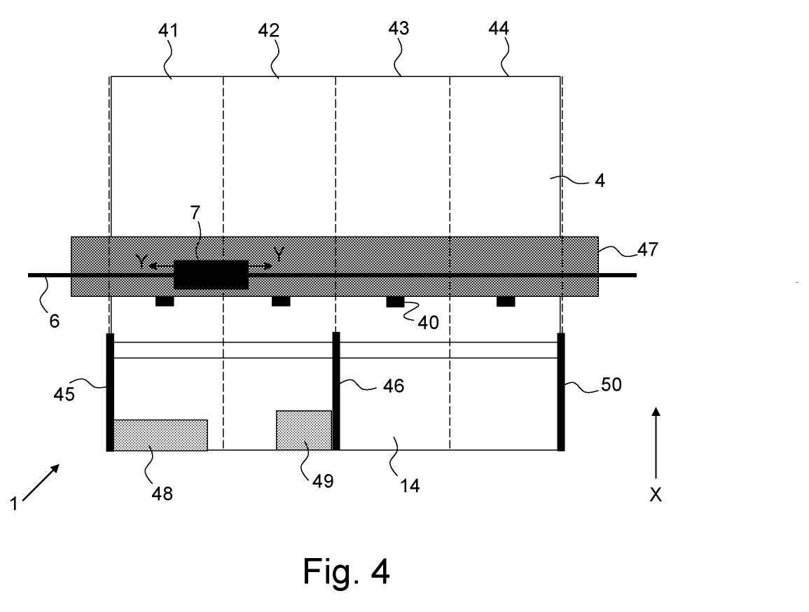

FIG. 4 shows schematically the printer 1 seen from above provided with a multi-lane concept. The belt 4 is divided into lanes 41, 42, 43, 44 that are parallel in the transport direction X of the print media on the media input unit 14 and the belt 4. In parallel, a plurality of individual print media may be transported perpendicular to a scanning direction Y of the print station 7 of the printer 1. The print media may have different dimensions. Positions of each individual print medium is determined. A designated image specific for each print medium is jetted on each respective print medium. The above steps are repeated such that print media are printed in parallel lanes 41, 42, 43, 44 perpendicular to the scanning direction.

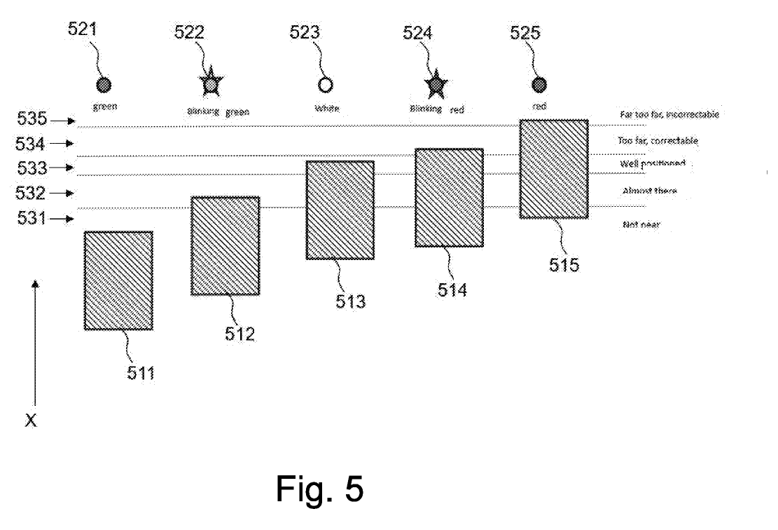

In this example, four lanes 41, 42, 43, 44 are depicted. However, according to the disclosure the number of lanes may be in principle two or more lanes. A number of preferred configurations will be described in FIG. 5.

The position and the widths of the lanes 41, 42, 43, 44 on the belt 4 and the media input unit 14 are configurable via the user interface 11. Such a configuration is determined by the positions of one or more guiding bars 45, 46, 50.

The lanes 41, 42, 43, 44 are completely or partially bound by guiding bars 45, 46, 50 extending on the media input unit 14 towards the belt 4 in the transport direction X of the belt 4.

The print media may be aligned by means of the guiding bars 45, 46, 50. A print media piece may be left aligned or right aligned. For example print media piece 48 is left aligned along guiding bar 45 and print media piece 49 is right aligned along guiding bar 46. The print media may have different sizes, i.e. different lengths and/or widths.

A housing 47 above the belt 4 comprises a guiding rail 6 via which the print station 7 is able to travel in the scanning direction Y. The housing 47 also comprises one or more sensors (not shown) which are downward directed to the belt 4 for detecting a presence and a position of print media in the lanes 41 – 44. The housing 47 also comprises signaling objects 40 at the front side directed to the media input unit 14 for signaling if a lane is disabled or enabled. A signaling object 40 is positioned above each of the defined lanes 41 – 44.

The signaling object 40 preferably is an LED lamp. The signaling object 40 may be deactivated when the lane is disabled or when in use but no media may be fed at the moment. The signaling object 40 may be activated when the lane is enabled. However, other ways of signaling in order to indicate that a lane is disabled or enabled may be envisioned. The signaling object may send out different colors of light depending on the situation.

The signaling object 40 indicates the current status of the lane. The user does not have to know all the limitations about when a lane can be used and where the media exactly has to be positioned. The system takes all the rules for use and positioning the rigids into account.

When the signaling object 40 is off, the lane is not available and a user is supposed to not feed a rigid to the lane. As soon as the lane becomes available, a rigid can be fed, which also means that there is an image that can be printed in that lane. The user may feed the rigid.

FIG. 5 is a schematic diagram of positions 531 – 535 of a leading edge of the fed print media 511 – 515 respectively on the media support plane. For reach of the positions 531 – 535, an example of a status 521 – 525 of the signaling object is depicted.

When the signaling object 40 is off, the lane is not available and a user is supposed to not feed a rigid to the lane. As soon as the lane becomes available, the signaling object is 521 green. A rigid 511 can be laid down in the position 531, which also means that there is an image that can be printed in that lane. The user may feed the rigid in the transport direction X. As soon as the feeding (front) edge of the rigid 512 print media is almost at the right position (“about there”, i.e. position 532) the LED starts 522 blinking green. The user feeds the rigid a little bit further. If the user moves the rigid 514 too far (“too far”, correctable, i.e. position 534) the LED starts to 524 blink red. The user then retracts the media 514.

As soon as the rigid 513 is at the right position 533 the LED turns 523 white. The position 533 is a start position for a start of an automatic transport of the rigid 513 to the medium support plane for ejecting marking material on the rigid 513 by the print station 7. The user stops feeding the rigid 513 and holds it at this position. The signaling object 40 is turned off, so that the user knows that he should release the rigid 513. The leading edge detection of the rigid 513 takes place. The vacuum is turned on so that the rigid 513 is fixed to the belt. The media 513 is transported by the belt to the print station 7 of the printer 1.

When the signaling object 40 is off (and the lane not available), but the user still feeds a rigid, the signaling object will start to 524 blink red as soon as the rigid 511 – 514 is detected. The user can retract the media 511 - 514.

If the printer is printing and the media 515 is moved in a too far position 535 onto the belt than the vacuum is turned on (to prevent printhead collisions) and the signaling object 40 of that lane turns 525 red (not blinking anymore). Now the user is not able to retract the media 515 anymore and it is transported to the output side of the printer, without being printed upon by the print station 7 of the printer 1.

The exact colors of the signaling object 40 in the different positions 531 – 535 may be implemented in many different ways withing the scope of the present disclosure. If the signaling object 40 is blinking and at what positions 531 – 535 may also be implemented in many different ways within the scope of the present disclosure.

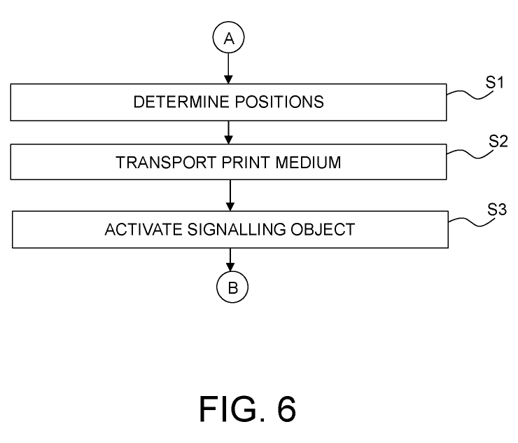

FIG. 6 describes an example of a method according to the disclosure.

The method starts at a starting point A that leads to a first step S1.

In the first step S1, the plurality of different positions 531 – 535 is determined in the plurality of parallel lanes for the individual print media. The plurality of positions 531 - 535 is spread in the transport direction X perpendicular to a scanning direction Y of the print station 7.

In a second step S2, the plurality of individual print media is transported in parallel but not necessarily simultaneously in the transport direction X in the plurality of parallel lanes towards the medium support plane.

In a third step S3, the signaling object 40 is independently activated, based on the determined plurality of different positions 531 - 535, in each lane when a leading edge of a fed individual print medium reaches each of the different positions 531 - 535 in the lane. Each determined position 531 – 535 in a lane has a different distance to the start position 533 for a start of an automatic transport of the print medium 513 to the medium support plane for ejecting marking material on the print medium 513 by the print station 7. Each determined position 531 – 535 in the lane corresponds to a different signal 521 – 525 given by the signaling object 40 in the lane when activated.

### The method ends at an end point B.

By applying the method, the user knows where to feed rigids without the need to look at the local user interface screen 11 of printer 1 as shown in FIG. 1. The user does not have to know all the rules that may make a lane unavailable. The user gets feedback about the current state of the lanes. The user is able to feed the rigid at the right position where the exact location of the front edge can be detected. There is no need for a guide line indication which would also mean that the guide lines have to be extended to that position with a risk of damaging the belt, e.g. just above the belt, above the vacuum. The user is able to correct positioning if the rigid is a little bit too far. The user knows when he has to hold and when to release the rigid. The user can feed the rigid rather fast and just slowing down near the desired position.

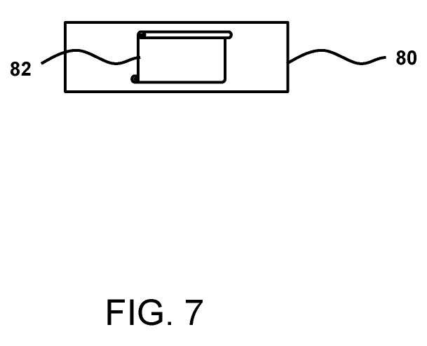

FIG. 7 schematically shows a non-transitory software/computer-readable storage medium 80 according to the disclosure. The software medium 80 comprises executable code 82 configured to, when executed, perform the method according to the disclosure, e.g. as described with respect to either the printing system 1 shown in FIG. 1 or the method of controlling the printing system 1 according to FIG. 6 and/or according to any of the variants and modifications of the printing system 1 and/or of the method described herein.

The non-transitory software medium 80 may, specifically, be formed as a CD or a CD-ROM, a DVD or a DVD-ROM, a BluRay disc or a BluRay-ROM disc, a magnetic hard drive, a solid state disk (SSD) hard drive, a USB memory device and so on.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms "comprise", "comprising", "include", "including", "contain", "containing", "have", "having", and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms "a" and "an" used herein are intended to be understood as meaning one or more unless explicitly stated otherwise. Moreover, the terms "first", "second", "third", etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the scope of the present disclosure, and all such modifications as would be obvious to one skilled in the art are intended to be included within the scope of the following claims.

1. A method for a printer comprising a transport device comprising an endless transport belt supported on a pair of support rollers, a medium support plane is defined between the support rollers, and a print station is provided over the medium support plane, the method comprising:
determining a plurality of different positions in a plurality of parallel lanes of the belt for individual print media, the plurality of positions spread in a direction perpendicular to a scanning direction of the print station;
transporting in parallel but not necessarily simultaneously a plurality of individual print media perpendicular to the scanning direction of the print station in the plurality of parallel lanes towards the medium support plane; and
based on the determined plurality of different positions, independently activating a signaling object in each lane when a leading edge of a fed individual print medium reaches each of the different positions in the lane,
wherein each determined position in a lane has a different distance to a start position for a start of an automatic transport of the print medium to the medium support plane for ejecting marking material on the print medium by the print station, and each determined position in the lane corresponds to a different signal given by the signaling object in the lane when activated.

2. The method according to claim 1, further comprising communicating, using the signaling object, to an operator of the printer that the fed print medium in a lane is one of the following: not near the start position, almost reaching the start position, at the start position, just beyond the start position but correctable by retraction, or far beyond the start position and not retractable.

3. The method according to claim 2, further comprising cancelling a print action before the print medium reaches the print station when the signaling object is communicating that the fed print medium is far beyond the start position and not retractable.

4. The method according to claim 2, wherein the communicating step comprises the signaling object blinking when the fed print medium is almost reaching the start position or the fed print medium is just beyond the start position and the signaling object is on in the other positions.

5. The method according to claim 4, wherein the communicating step comprises the signaling object blinking green when the fed print medium has almost reached the start position and the signaling object blinking red when the fed print medium is just beyond the start position but retractable.

6. The method according to claim 4, wherein the communicating step comprises the signaling object is on and solid signaling white or blue when the fed print medium is at the start position and the signaling object solid signaling red when the fed print medium is far beyond the start position and not retractable.

7. The method according to claim 1, further comprising turning off the signaling object when the lane is not available.

8. The method according to claim 1, wherein the printer includes a camera system provided above the print medium surface, the method further comprising detecting, using the camera system, a leading edge of the print medium.

9. The method according to claim 8, further comprising, when the lane is not available, the signaling object starting blinking red when a print medium is fed into the lane and detected by the camera system.

10. The method according to claim 8, further comprising , when the signaling object is solid signaling white or blue, turning on a vacuum system to hold the print medium at its place, turning off the signaling object, the camera system detecting the leading edge of the print medium, and activating the transport belt for a transport of the print medium to the print station.

11. A printer comprising:
a transport device comprising an endless transport belt supported on a pair of support rollers that defines a medium support plane therebetween;
a print station is provided over the medium support plane;
a plurality of lanes for feeding the print media to be printed upon;
a signaling element provided over each lane; and
a print controller configured to execute the steps of the method according to claim 1.

12. The printer according to claim 11, further comprising at least one camera system configured to detect a feeding of a print medium in the print medium plane.

13. The printer according to claim 11, wherein the printer is a hybrid printer for printing on rigid print media as well as on flexible print media.

14. The printer according to claim 11, wherein the signaling element is a LED light.

15. A non-transitory computer-readable storage medium storing program code, which when loaded into a print controller of a digital printer, causes the print controller to execute the steps of the method according to claim 1.
